(19) United States
(12) Patent Application Publication
(10) Pub. No.: US 2026/0062297 A1
(43) Pub. Date: Mar. 5, 2026

(54) DEHYDRATION METHOD AND DEHYDRATION DEVICE OF IRON PHOSPHATE HYDRATE

(71) Applicant: Sichuan Jinhengfengling New Material Technology Co., Ltd., Mianyang City (CN)

(72) Inventors: Wei ZHANG, Mianyang City (CN); Xiaohui LIU, Mianyang City (CN); Lin CHEN, Mianyang City (CN)

(73) Assignee: Sichuan Jinhengfengling New Material Technology Co., Ltd., Mianyang City (CN)

(21) Appl. No.: 18/944,705

(22) Filed: Nov. 12, 2024

(30) Foreign Application Priority Data
Aug. 30, 2024 (CN) 202411204332.1

(51) Int. Cl. C01B 25/37

(52) U.S. Cl. CPC C01B 25/375

(57) ABSTRACT

Provided are a dehydration method and a dehydration device of an iron phosphate hydrate. The dehydration method includes the following steps: subjecting the iron phosphate hydrate to microwave irradiation dehydration to obtain an anhydrous iron phosphate. The dehydration device includes a microwave heating assembly, a heat receiving assembly, and a transmission assembly; wherein the microwave heating assembly includes a microwave generator and a microwave heater connected to the microwave generator; the heat receiving assembly includes an open material storage device, and the open material storage device is made from a material that is not magnetic substances; and the transmission assembly includes a conveyor belt, and the open material storage device is arranged on a surface of the conveyor belt.

### CROSS REFERENCE TO RELATED APPLICATION

This patent application claims the benefit and priority of Chinese Patent Application No. 202411204332.1 filed with the China National Intellectual Property Administration on Aug. 30, 2024, the disclosure of which is incorporated by reference herein in its entirety as part of the present application.

### TECHNICAL FIELD

The present disclosure relates to the technical field of dehydration methods, and in particular to a dehydration method and a dehydration device of an iron phosphate hydrate.

### BACKGROUND

With the rapid development of new energy vehicles, global new energy materials have developed by leaps and bounds. Lithium iron phosphate batteries have seen particularly strong development in recent years due to their safety, stability, and long-term recycling capabilities. Anhydrous iron phosphate is a necessary raw material for the preparation of lithium iron phosphate.

Anhydrous iron phosphate is obtained by removing water of crystallization from iron phosphate hydrates. For example, FePO₄·2H₂O requires a temperature of 150° C. to 200° C. during the removing water of crystallization. In the prior art, the anhydrous iron phosphate is prepared by heating and dehydrating iron phosphate hydrates in a kiln such as a rotary kiln. However, the dehydration methods still have shortcomings. On one hand, rotary kilns or tunnel kilns heat iron phosphate hydrates through heat exchange combined with heat convection, which have low heat transfer efficiency, high temperature gradient required, huge heat loss, and great energy consumption. On the other hand, iron phosphate hydrate particles and kiln parts such as kiln walls at high temperatures are repeatedly rubbed for a long time, easily introducing particles such as iron or iron oxides as a magnetic foreign substance. In the production process of lithium iron phosphate, the magnetic foreign substance is difficult to be cleaned up, therefore seriously affecting the performance of batteries.

### SUMMARY

In view of this, an object of the present disclosure is to provide a dehydration method and a dehydration device of an iron phosphate hydrate. In the present disclosure, the dehydration method has low energy consumption and does not introduce other impurities, and the iron phosphate hydrate prepared by the same shows a high purity.

To achieve the above object, the present disclosure provides the following technical solutions:

The present disclosure provides a method for dehydrating an iron phosphate hydrate, including the following steps: subjecting the iron phosphate hydrate to microwave irradiation dehydration to obtain an anhydrous iron phosphate.

In some embodiments, the microwave irradiation dehydration is conducted at a frequency of 0.3 GHz to 300 GHz.

In some embodiments, the microwave irradiation dehydration is conducted at a power of 4 kW to 100 kW.

In some embodiments, the microwave irradiation dehydration is conducted for 80 min to 100 min.

In some embodiments, the iron phosphate hydrate comprises one or more selected from the group consisting of iron phosphate dihydrate, iron phosphate monohydrate, and iron phosphate octahydrate.

The present disclosure further provides a dehydration device for the dehydration method according to the above technical solution, including a microwave heating assembly, a heat receiving assembly, and a transmission assembly; wherein the microwave heating assembly includes a microwave generator 11 and a microwave heater 13 connected to the microwave generator 11; the heat receiving assembly includes an open material storage device 21, and the open material storage device 21 is made from a material excluding magnetic substances; and the transmission assembly includes a conveyor belt 31, and the open material storage device 21 is arranged on a surface of the conveyor belt 31.

In some embodiments, the microwave heating assembly further includes a bracket 14 configured to support the microwave heater 13.

In some embodiments, the microwave heating assembly further includes a separator 15 arranged between the microwave heater 13 and the open material storage device 21.

In some embodiments, the dehydration device further includes a channel-shaped control box 4, where the microwave generator 11 is arranged on an upper surface of the channel-shaped control box 4; the microwave heater 13, the bracket 14, the separator 15, and the open material storage device 21 are arranged inside the channel-shaped control box 4; and the conveyor belt 31 enters from one side of the channel-shaped control box 4 and is led out from the other side of the channel-shaped control box 4.

In some embodiments, the transmission assembly further includes a frame 32 configured to support the conveyor belt 31.

The present disclosure provides a method for dehydrating an iron phosphate hydrate, including the following steps: subjecting the iron phosphate hydrate to microwave irradiation dehydration to obtain an anhydrous iron phosphate. Crystal water in the iron phosphate hydrate is removed by microwave irradiation without heating the iron phosphate hydrate to not less than 150° C. and without transfer heat to make the water molecules gain energy such that it is separated from the iron phosphate molecules, resulting in low energy consumption. Moreover, the dehydration method according to the present disclosure does not need to remove the crystal water in a rotary kiln or a tunnel kiln, and does not introduce new impurities such as magnetic foreign substances. The anhydrous iron phosphate prepared by the method shows a high purity and is used in batteries without affecting the performance of the batteries. Under the microwave irradiation, a large number of water molecules in the iron phosphate hydrate gain energy and then overflow out from the iron phosphate hydrate, forming countless tiny porous channels and making the anhydrous iron phosphate structure expand and loosen. This process is beneficial to the grinding process and lithium insertion process of the production of the downstream lithium iron phosphate, thereby comprehensively improving the performance of the terminal product lithium iron phosphate. Moreover, the dehydration method according to the present disclosure has the advantages of simple process, convenient operation, and low cost, and is suitable for industrial production.

The present disclosure provides a dehydration device for the dehydration method as described in the above technical solutions, including a microwave heating assembly, a heat receiving assembly, and a transmission assembly; where the microwave heating assembly includes a microwave generator 11 and a microwave heater 13 connected to the microwave generator 11; the heat receiving assembly includes an open material storage device 21, and the open material storage device 21 is made from a material excluding magnetic substances; and the transmission assembly includes a conveyor belt 31, and the open material storage device 21 is arranged on a surface of the conveyor belt 31. The dehydration device according to the present disclosure generates microwaves through the microwave generator 11, and the microwave heater 13 converts microwave energy into thermal energy. When the iron phosphate hydrate passes through the microwave heater 13, the microwave energy generated by the microwave generator 11 is absorbed by the iron phosphate hydrate, such that water inside the iron phosphate hydrate is rapidly heated up and vaporized, thereby achieving the dehydration of the iron phosphate hydrate to obtain an anhydrous iron phosphate. The dehydration device according to the present disclosure is used to dehydrate the iron phosphate hydrate with low energy consumption, and countless tiny porous channels are formed in the material during the microwave irradiation, making the anhydrous iron phosphate structure expand and loosen. This process is beneficial to the grinding process and lithium insertion process of the production of downstream lithium iron phosphate, thereby comprehensively improving the performance of the terminal product lithium iron phosphate. Further, the iron phosphate hydrate does not need to be turned over and does not come into contact with other equipment components except for the open material storage device 21 that does not contain magnetic substances during the dehydration, thus significantly reducing the risk of introducing magnetic foreign substances, such that the anhydrous iron phosphate prepared by the method shows a high purity. Moreover, the device according to the present disclosure has a simple structure and a low cost.

### BRIEF DESCRIPTION OF THE DRAWINGS

FIGURE shows a structural schematic diagram of the dehydration device, where numeral references are listed below:

11 refers to microwave generator, 12 refers to connecting waveguide tube, 13 refers to microwave heater, 14 refers to bracket, 15 refers to separator, 21 refers to open material storage device, 31 refers to conveyor belt, 32 refers to frame, and 4 refers to channel-shaped control box.

### DETAILED DESCRIPTION OF THE EMBODIMENTS

The present disclosure provides a method for dehydrating an iron phosphate hydrate, including the following steps: subjecting the iron phosphate hydrate to microwave irradiation dehydration to obtain an anhydrous iron phosphate.

In the present disclosure, unless otherwise specified, all materials and equipment used are commercially available items in the art.

In the present disclosure, the iron phosphate hydrate is preferably one or more selected from the group consisting of iron phosphate dihydrate, iron phosphate monohydrate, and iron phosphate octahydrate, more preferably iron phosphate dihydrate.

In the present disclosure, the microwave irradiation dehydration is conducted at a frequency of preferably 0.3 GHz to 300 GHz, more preferably 10 GHz to 250 GHz; in a specific embodiment, the microwave irradiation dehydration is conducted at a frequency of 0.3 GHz, 0.5 GHz, 1 GHz, 10 GHz, 50 GHz, 100 GHz, 150 GHz, 200 GHz, 250 GHz, or 300 GHz. The microwave irradiation dehydration is conducted at a power of preferably 4 kW to 100 kW, more preferably 20 kW to 50 kW; in a specific embodiment, the microwave irradiation dehydration is conducted at a power of 4 kW, 10 kW, 20 kW, 30 kW, 40 kW, 50 kW, 60 kW, 70 kW, 80 kW, 90 kW, or 100 kW; and the microwave irradiation dehydration is conducted for preferably 80 min to 100 min, more preferably 85 min to 95 min, and even more preferably 90 min.

The present disclosure further provides a dehydration device for the dehydration method as described in the above technical solution, having a structural schematic diagram as shown in the FIGURE. The dehydration device is described in detail below in conjunction with the FIGURE.

The dehydration device according to the present disclosure includes a microwave heating assembly, a heat receiving assembly, and a transmission assembly; wherein the microwave heating assembly includes a microwave generator 11 and a microwave heater 13 connected to the microwave generator 11; the heat receiving assembly includes an open material storage device 21, and the open material storage device 21 is made from a material excluding magnetic substances; and the transmission assembly includes a conveyor belt 31, and the open material storage device 21 is arranged on a surface of the conveyor belt 31.

In the present disclosure, the microwave generator 11 is preferably connected to the microwave heater 13 via a connecting waveguide tube 12. In the present disclosure, the microwave heater 13 is configured to convert microwave energy generated by the microwave generator 11 into heat energy. In the present disclosure, the microwave generator is an electronic device that can generate microwave signals, which uses special electronic components and circuits to generate high-frequency electromagnetic oscillations, thereby generating microwave signals. The working principle of the microwave generator is based on the principle of oscillation circuit, which includes an oscillation circuit and an amplifier circuit. The oscillation circuit comprises a feedback circuit, and an inductor and a capacitor that can generate resonance. When charges oscillate between the inductor and the capacitor, an electromagnetic wave is generated. After the electromagnetic wave is amplified by the amplifier circuit, it becomes a microwave signal.

In the present disclosure, the microwave heating assembly preferably further includes a bracket 14 configured to support the microwave heater 13, and a separator 15 arranged between the microwave heater 13 and the open material storage device 21. The separator 15 is configured to prevent the material in the open material storage device 21 from splashing and to prevent dust from entering into the material.

In the present disclosure, the open material storage device 21 is made from a material being preferably plastic. In the present disclosure, there is no specific limitations on the plastic, and plastics known to those skilled in the art that do not contain magnetic substances and are not affected by microwave irradiation may be used.

In the present disclosure, the transmission assembly preferably further includes a frame 32 configured to support the conveyor belt 31, and the material of the frame 32 preferably includes metals. In the present disclosure, there is no specific limitations on the types of the metals, and any metals that can be used as a frame and are well known to those skilled in the art may be used.

In some embodiments of the present disclosure, the dehydration device further includes a channel-shaped control box 4, where the microwave generator 11 is arranged on an upper surface of the channel-shaped control box 4; the microwave heater 13, the bracket 14, the separator 15, and the open material storage device 21 are arranged inside the channel-shaped control box 4; and the conveyor belt 31 enters from one side of the channel-shaped control box 4 and is led out from the other side of the channel-shaped control box 4.

The method for dehydrating an iron phosphate hydrate is described in detail below with reference to the FIGURE. At room temperature, the iron phosphate hydrate is placed inside the open material storage device 21 which is arranged on a surface of the conveyor belt 31. The microwave generator 11 generates microwaves, which are transmitted to the microwave heater 13 through the connecting waveguide tube 12, and the microwave heater 13 converts microwave energy into heat energy. When the open material storage device 21 containing iron phosphate hydrate passes through the microwave heater 13, the microwave energy is absorbed by the iron phosphate hydrate, causing water inside the iron phosphate hydrate to heat up and vaporize rapidly, thereby dehydrating the iron phosphate hydrate to obtain the anhydrous iron phosphate. The separator 15 is arranged between the microwave heater 13 and the open material storage device 21, which can prevent the material in the open material storage device 21 from splashing and prevent dust from entering into the material. The conveyor belt 31 passes through the channel-shaped control box 4 and is supported by the frame 32. The microwave heater 13 is supported by the bracket 14.

To further illustrate the present disclosure, the dehydration method and the dehydration device of the iron phosphate hydrate provided by the present disclosure are described in detail below in conjunction with examples, but these examples should not be construed as limiting the claimed scope of the present disclosure.

### Example 1

The dehydration of iron phosphate dihydrate was conducted using the dehydration device shown in the FIGURE. 20.00 g of the iron phosphate dihydrate was subjected to microwave irradiation at 100 GHz and 5 kW for 90 min to obtain 16.162 g of anhydrous iron phosphate (with a water content of about 0.1%).

A thermogravimetric analysis experiment was conducted on the anhydrous iron phosphate. No mass loss was observed after heat preservation at 550° C. for 2 h, indicating that the dehydration was completed.

### Example 2

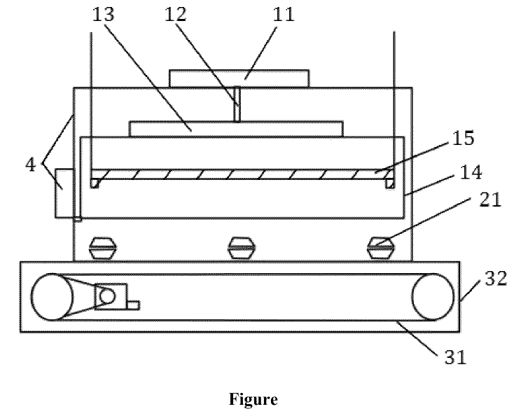

The dehydration of iron phosphate dihydrate was conducted using the dehydration device shown in the FIGURE. 1,000 g of the iron phosphate dihydrate was subjected to microwave irradiation at 100 GHz and 5 kW for 90 min to obtain 808.27 g of anhydrous iron phosphate (with a water content of about 0.12%).

A thermogravimetric analysis experiment was conducted on the anhydrous iron phosphate. No mass loss was observed after heat preservation at 550° C. for 2 h, indicating that the dehydration was completed.

### Example 3

The dehydration of iron phosphate dihydrate was conducted using the dehydration device shown in the FIGURE. 5,000 g of the iron phosphate dihydrate was subjected to microwave irradiation at 100 GHz and 5 kW for 90 min to obtain 4,042.56 g of anhydrous iron phosphate (with a water content of about 0.15%).

A thermogravimetric analysis experiment was conducted on the anhydrous iron phosphate. No mass loss was observed after heat preservation at 550° C. for 2 h, indicating that the dehydration was completed.

The above descriptions are merely preferred embodiments of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A method for dehydrating an iron phosphate hydrate, comprising the following steps:
subjecting the iron phosphate hydrate to microwave irradiation dehydration to obtain an anhydrous iron phosphate.

2. The method according to claim 1, wherein the microwave irradiation dehydration is conducted at a frequency of 0.3 GHz to 300 GHz.

3. The method according to claim 1, wherein the microwave irradiation dehydration is conducted at a power of 4 kW to 100 kW.

4. The method according to claim 3, wherein the microwave irradiation dehydration is conducted for 80 min to 100 min.

5. The method according to claim 1, wherein the iron phosphate hydrate is one or more selected from the group consisting of iron phosphate dihydrate, iron phosphate monohydrate, and iron phosphate octahydrate.

6. A dehydration device for the method according to claim 1, comprising a microwave heating assembly, a heat receiving assembly, and a transmission assembly; wherein
the microwave heating assembly comprises a microwave generator (11) and a microwave heater (13) connected to the microwave generator (11);
the heat receiving assembly comprises an open material storage device (21), and the open material storage device (21) is made from a material excluding magnetic substances; and
the transmission assembly comprises a conveyor belt (31), and the open material storage device (21) is arranged on a surface of the conveyor belt (31).

7. The dehydration device according to claim 6, wherein the microwave irradiation dehydration is conducted at a frequency of 0.3 GHz to 300 GHz.

8. The dehydration device according to claim 6, wherein the microwave irradiation dehydration is conducted at a power of 4 kW to 100 kW.

9. The dehydration device according to claim 8, wherein the microwave irradiation dehydration is conducted for 80 min to 100 min.

10. The dehydration device according to claim 6, wherein the iron phosphate hydrate is one or more selected from the group consisting of iron phosphate dihydrate, iron phosphate monohydrate, and iron phosphate octahydrate.

11. The dehydration device according to claim 6, wherein the microwave heating assembly further comprises a bracket (14) configured to support the microwave heater (13).

12. The dehydration device according to claim 11, wherein the microwave heating assembly further comprises a separator (15) arranged between the microwave heater (13) and the open material storage device (21).

13. The dehydration device according to claim 6, further comprising a channel-shaped control box (4), wherein the microwave generator (11) is arranged on an upper surface of the channel-shaped control box (4); the microwave heater (13), the bracket (14), the separator (15), and the open material storage device (21) are arranged inside the channel-shaped control box (4); and
the conveyor belt (31) enters from one side of the channel-shaped control box (4) and is led out from the other side of the channel-shaped control box (4).

14. The dehydration device according to claim 11, further comprising a channel-shaped control box (4), wherein the microwave generator (11) is arranged on an upper surface of the channel-shaped control box (4); the microwave heater (13), the bracket (14), the separator (15), and the open material storage device (21) are arranged inside the channel-shaped control box (4); and
the conveyor belt (31) enters from one side of the channel-shaped control box (4) and is led out from the other side of the channel-shaped control box (4).

15. The dehydration device according to claim 12, further comprising a channel-shaped control box (4), wherein the microwave generator (11) is arranged on an upper surface of the channel-shaped control box (4); the microwave heater (13), the bracket (14), the separator (15), and the open material storage device (21) are arranged inside the channel-shaped control box (4); and
the conveyor belt (31) enters from one side of the channel-shaped control box (4) and is led out from the other side of the channel-shaped control box (4).

16. The dehydration device according to claim 6, wherein the transmission assembly further comprises a frame (32) configured to support the conveyor belt (31).
